(19) United States
(12) Patent Application Publication
(10) Pub. No.: US 2026/0138453 A1
(43) Pub. Date: May 21, 2026

(54) AUTOMOBILE WITH FORWARD ARRANGEMENT OF PASSENGER CABIN

(71) Applicant: AEHRA, Inc., Houston, TX (US)

(72) Inventors: Hazim Nada, Campione d'Italia (Como) (IT); Filippo Perini, Bobbio (Piacenza) (IT); Alessandro Serra, Giaveno (TO) (IT); Alessandro Salvagnin, Nonantola (MO) (IT); Marco Quamori Tanzi, Varese (VA) (IT); Giuseppe Ceccio, Torino cap (IT); Niccolo Tassi, Lodi (LO) (IT)

(21) Appl. No.: 19/118,982

(22) PCT Filed: Oct. 4, 2023
(86) PCT No.: PCT/US2023/075905

§ 371 Date: Apr. 7, 2025

Related U.S. Application Data
(60) Provisional application No. 63/379,535, filed on Oct. 14, 2022.
(60) Provisional application No. 63/387,480, filed on Dec. 14, 2022.

(51) Int. Cl. B60K 35/53; B60H 3/00; B60J 1/02; B60K 35/22; B60K 37/00; B60N 2/20; B60R 1/26; B62D 1/183; B62D 25/04

(52) U.S. Cl. CPC B60K 35/53; B60H 3/00; B60J 1/02; B60K 35/22; B60K 37/00; B60N 2/206; B60R 1/26; B62D 1/183; B62D 25/04

(57) ABSTRACT

An automobile or electric vehicle has a passenger cabin with a forward arrangement that maximizes interior passenger cabin space and can accommodate four tall passengers (e.g. having a height of up to 2.1 m). The automobile comprises a dashboard having a depth between a windshield touchdown location and a distal end of the dashboard of between about 1080 mm and about 1220 mm and a screen movable between a retracted driving position and an extended conference position relative to the dashboard.

### INCORPORATION BY REFERENCE TO ANY PRIORITY APPLICATIONS

This application claims priority to U.S. Provisional Application No. 63/387,480 filed Dec. 14, 2022, and U.S. Provisional Application No. 63/379,535 filed Oct. 14, 2022, the entirety of both of which are hereby incorporated by reference and should be considered a part of this specification.

### BACKGROUND

### Field

The invention is directed to an automobile, and more particularly to an electric vehicle with a passenger cabin having a forward arrangement.

### Description of the Related Art

Existing four-passenger electric vehicles are built on platforms for existing legacy designs, are cramped and do not accommodate taller individuals. Such vehicles also fail to provide a mobile workspace for consumers and do not optimally use the interior of the vehicle.

### SUMMARY

In accordance with one aspect of the disclosure, an electric vehicle is provided with an interior cabin arrangement that maximizes interior cabin space and can accommodate four tall passengers (e.g., having a height of up to 2.1 m).

In accordance with one aspect of the disclosure, an electric vehicle is provided with an interior cabin arrangement that provides a mobile workspace. The interior cabin accommodates a large (e.g., 32 inch) folding screen that can be selectively retracted into the dashboard for storage and extended from the dashboard for use as a home theater, virtual meetings and/or can be connected to a user's computer, providing the user a mobile workspace that allows the user to work or relax within the cabin when the car is parked.

In accordance with one aspect of the disclosure, an electric vehicle is provided with an interior cabin arrangement that provides the user with a lounge interior experience. Both front seats can fold flat, allowing users to sit in the rear seats in a relaxed position (e.g., with their legs on the folded front seats), for example while viewing a movie or taking part in a video call on a large (e.g., 32 inch) folding scree that is selectively extendable from the dashboard.

In accordance with another aspect of the disclosure, an automobile is provided comprising a passenger cabin with two passenger rows between a wheelbase of the automobile. The automobile has a windshield having a windshield touchdown located between a center of a front wheel of the automobile and a front end of the automobile.

### BRIEF DESCRIPTION OF THE DRAWINGS

FIG. 1 is a perspective front view of an electric vehicle (EV).

FIG. 2 is a side view of the EV in FIG. 1.

FIG. 3 is a perspective front view of an electric vehicle (EV).

FIG. 4 is a side view of the EV in FIG. 3.

FIG. 5 is a silhouette of an existing vehicle showing a seating arrangement of passengers.

FIG. 6 is a silhouette of the EV in FIGS. 1-2 showing a seating arrangement of passengers.

FIG. 7 is a partial perspective view of a front of a passenger cabin in the EV of FIGS. 1-2.

FIG. 8 is a partial view of the front of the passenger cabin in FIG. 7.

FIG. 9 is a partial view of the front of the passenger cabin in FIG. 7 with a retractable screen in an extended position.

FIG. 10 is a partial perspective view of a front of a passenger cabin in the EV of FIG. 7 with a front passenger seat folded and passenger sitting in a rear seat with legs supported on the folded front seat.

FIG. 11 is a partial perspective view of a front of a passenger cabin in the EV of FIG. 7 with both front seats folded and passengers sitting in rear seats with legs supported on the folded front seats.

FIG. 12 is a schematic side view of the EV in FIGS. 1-2.

FIG. 13 is a partial view of the front of a passenger cabin for the electric vehicle in FIGS. 1-4 with a screen in a first position.

FIG. 14 is a partial view of the front of a passenger cabin for the electric vehicle in FIGS. 1-4 with the screen in a second position.

FIGS. 15-17 show partial views of an air purifier on the dashboard of the electric vehicle in FIGS. 1-4.

FIGS. 18-19 show partial views of the passenger cabin for the electric vehicle in FIGS. 1-4 showing an air purifier in a tunnel portion of the cabin.

### DETAILED DESCRIPTION

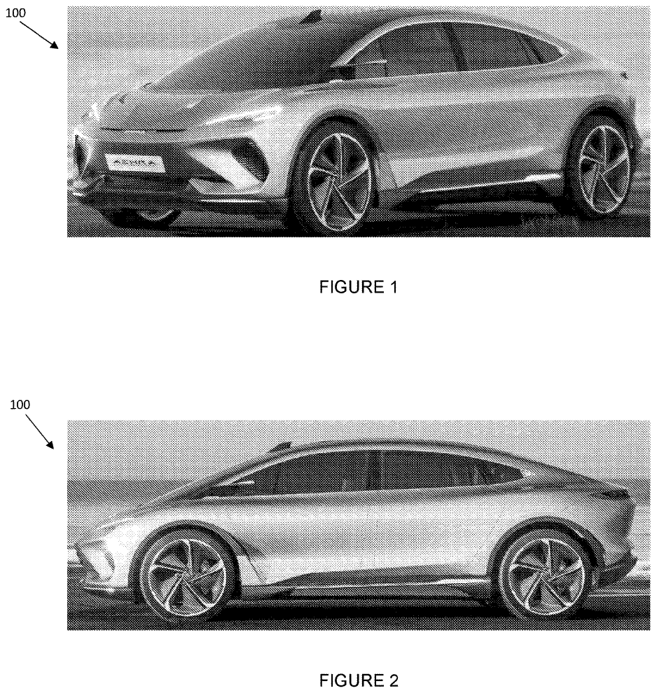

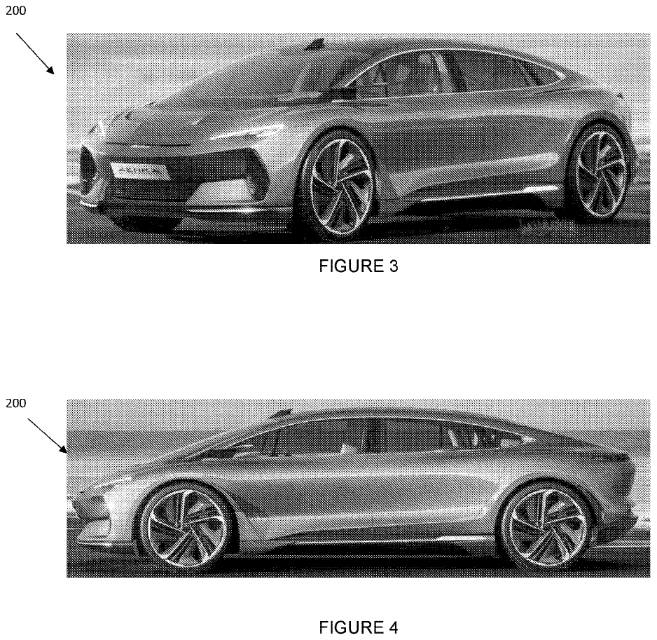

Disclosed herein are automobiles with a passenger cabin having a forward arrangement. FIGS. 1-2 show an automobile 100 (e.g., a sports utility vehicle or SUV) with two passenger rows for accommodating 4-5 passengers and having a forward passenger cabin arrangement as further discussed below. FIGS. 3-4 show an automobile 200 (e.g., a sedan) also having two passenger rows for accommodating 4-5 passengers and having a forward passenger cabin arrangement.

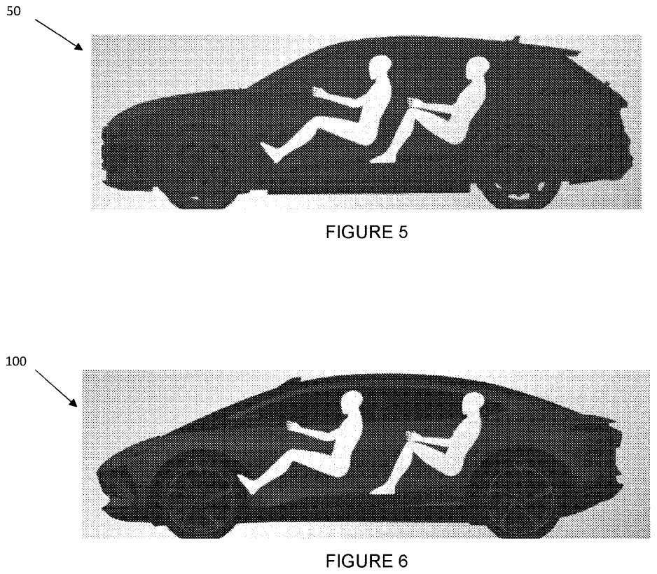

FIG. 5 shows a silhouette of an existing vehicle 50 with a typical passenger cabin arrangement. FIG. 6 shows a silhouette of the automobile 100 in FIGS. 1-2, showing how the forward passenger cabin arrangement results in the front passengers being located further forward toward the front of the automobile 100 (as compared with the vehicle 50) and advantageously provides increased space (e.g., leg room) between the front passengers and the rear passengers (as compared with the vehicle 50). Such increased space advantageously provides rear passengers with increased comfort.

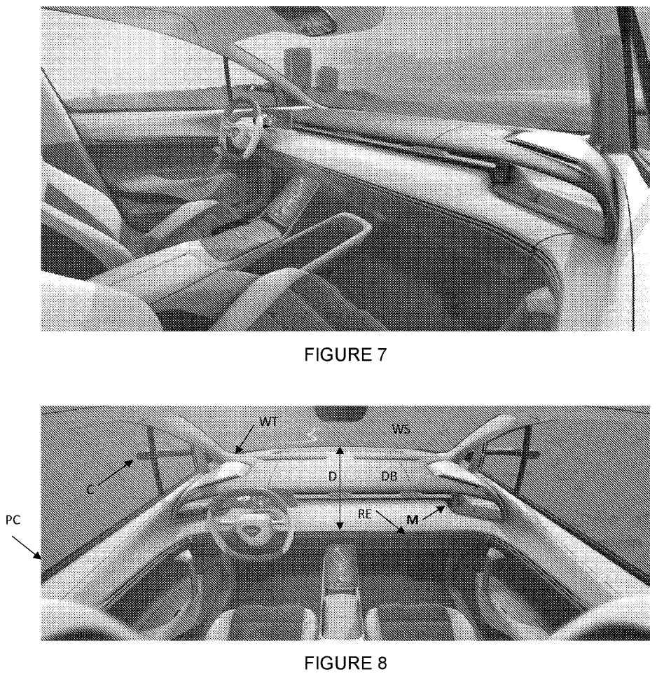

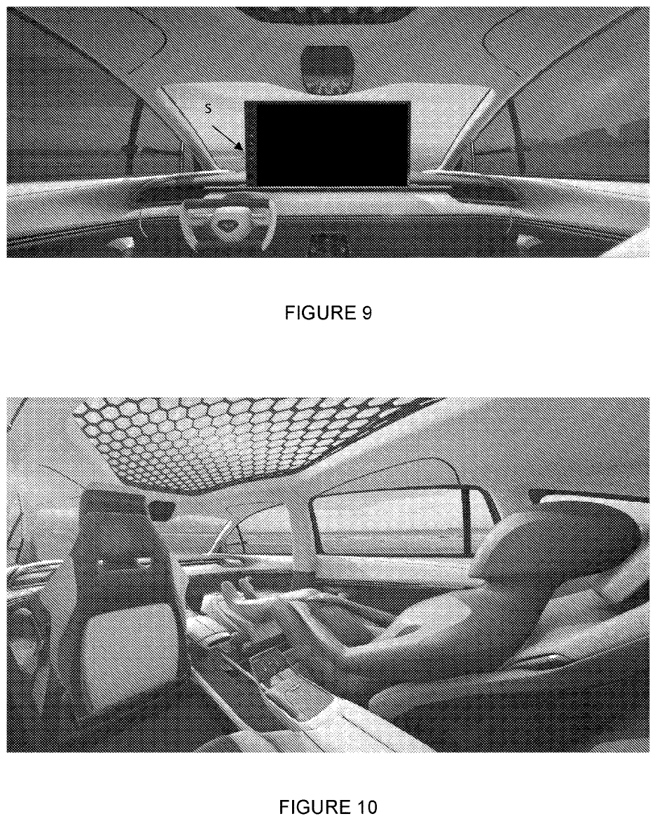

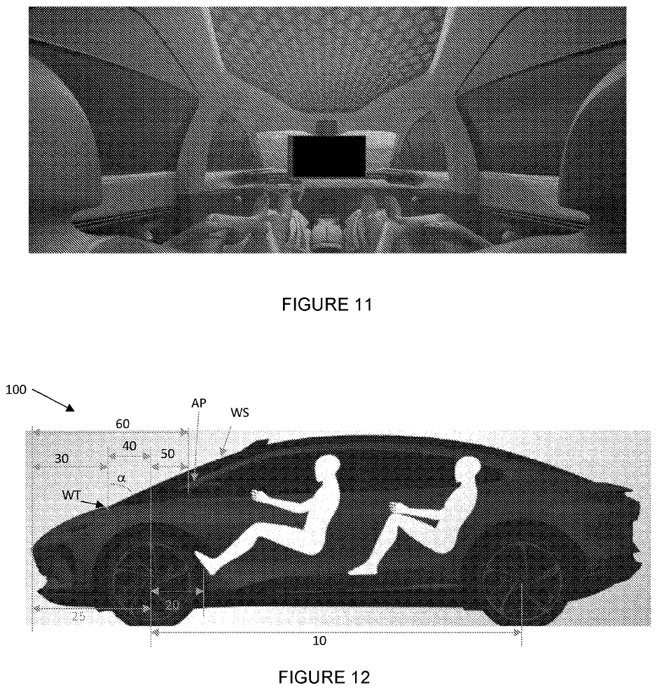

FIGS. 6-11 show partial views of an inside of a passenger cabin PC of an automobile (e.g., the automobile 100) with a forward arrangement. The forward arrangement facilitates additional functionality of the passenger cabin PC that are not possible in an existing vehicle. As shown in FIGS. 7-8, the passenger cabin PC can include a dashboard DB with built-in rear-view monitors M (or video displays) that communicate with rear-facing cameras C and display images provided by the rear-facing cameras C. The rear-view monitors M allow the driver and front passenger to readily see the environment (e.g., road, cars) behind the automobile, and can be disposed in a left end and a right end (e.g., opposite ends) of the dashboard DB (e.g., disposed adjacent opposite sides of a screen S, S′). As shown in FIG. 9-11, the forward arrangement of the passenger cabin PC allows the dashboard DB to have a longer span or distance D between the windshield touchdown WT and the rear end RE of the dashboard. In on implementation, the distance D (e.g., depth) between the windshield touchdown WT and the rear end RE (e.g., distal end) of the dashboard is between about 1080 mm to 1220 mm, such as about 1150 mm. Advantageously, the larger dashboard DB made possible by the forward arrangement of the passenger cabin PC accommodates a movable (e.g., foldable) screen S that can fully retract within the dashboard DB and can extend out of the dashboard DB to provide a large viewing screen (e.g., 32 inch wide screen) that can be used for entertainment (e.g., watching movies), video calls or be connected (wirelessly) to a computer (e.g., laptop computer) while the automobile is parked. As shown in FIGS. 9 and 11, the steering wheel can fold downward when the screen S is extended to provide an unobstructed view of the screen S. As shown in FIGS. 9-10, both front seats can fold down to fully flat positions (e.g., so a seat back folds onto a seat bottom), allowing passengers to sit in the rear seats and use the folded front seats as leg rests, for example while watching a video on the screen S. The size of the passenger cabin PC and forward arrangement thereof allows sufficient distance between the rear seats and the screen S to allow the passengers effective viewing of the screen S (e.g., of the 32 inch wide screen). In one implementation, not shown, the front row of passenger seats can include a center seat and the steering wheel can be aligned with the center seat, allowing a center passenger in the front row to operate the automobile 100.

FIG. 12 shows a schematic of the automobile 100 with the forward arrangement for the passenger cabin PC as described above. The forward arrangement of the passenger cabin PC is facilitated by the relationship between several components of the automobile 100, as described below. The automobile 100 can have a first distance 10 between the wheels (e.g., between the center of the wheels, the wheel base), a second distance 20 between a center of the front wheel and the foot of the front passenger in the passenger cabin PC, a third distance 25 between the center of the front wheel and the front of the automobile 100, a fourth distance 30 between the windshield touchdown WT and the front of the automobile 100, a fifth distance 40 between the windshield touchdown WT and the center of the front wheel, a sixth distance 50 between the A-pillar AP and the center of the front wheel and a seventh distance between the A-pillar AP and the front of the automobile 100. The windshield WS can extends at an angle α from the windshield touchdown WT. In some implementations, the angle a can be between 60°-70°. In one example, the angle α can be about 62°. In another example, the angle α can be about 65°. In another example, the angle α can be about 68°. As shown in FIG. 12, the windshield touchdown WT is between the center of the front wheel and the front of the automobile 100. In one example, the windshield touchdown WT is at or in front of a front edge of the front wheel.

The second distance 20 (between the center of the front wheel and the foot of the front passenger, such as the furthest forward position of a passenger foot in the passenger cabin PC) can be between 10-15% of the first distance 10 or wheelbase. The third distance 25 (between the center of the front wheel and the front of the automobile 100) can be between 25-35% of the first distance 10 or wheelbase. In one example, where the first distance 10 (e.g., wheelbase) is about 3070 mm, the second distance 20 can be about 440 mm and the third distance 25 can be about 990 mm. In another example, the second distance 20 can be about 390 mm and the third distance can be about 1000 mm when the first distance 10 (e.g., wheelbase) is about 3070 mm.

The fourth distance 30 (between the windshield touchdown WT and the front of the vehicle) can be between 15-25%, such as about 20%, of the first distance 10 or wheelbase. The fifth distance 40 (between the windshield touchdown WT and the center of the front wheel) can be between 5-15%, such as about 10%, of the first distance 10 or wheelbase. In one example, the fourth distance 30 can be about 640 mm and the fifth distance 40 can be about 335 mm when the first distance 10 is about 3085 mm.

The sixth distance 50 (between the A-pillar and the center of the front wheel) can be between 1-5%, such as about 1%, of the first distance 10 or wheelbase. A seventh distance 60 (between the A-pillar and the front of the vehicle) can be between 30-35%, such as about 32%, of the first distance 10 or wheelbase. In one example, the sixth distance 50 can be about 50 mm and the seventh distance 60 can be about 1000 mm when the first distance 10 is about 3085 mm.

The relationship between the different parameters described above facilitate the forward arrangement of the passenger cabin PC. This provides the advantages discussed above for providing a spacious passenger cabin with increased leg room that accommodates larger individuals, and facilitates the use of a large screen S for entertainment, video conferencing, advantageously facilitating use of the automobile 100 for remote work and relaxation/entertainment.

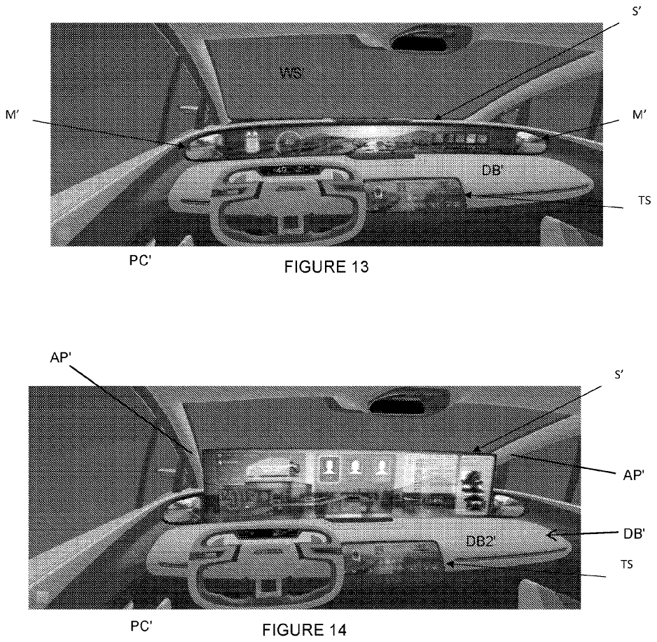

FIGS. 13-14 shows partial views of a front of a passenger cabin PC′ for the automobile or electric vehicle 100, 200 in FIGS. 1-4. Some of the features of the passenger cabin PC′ in FIGS. 13-14 are similar to features of the passenger cabin PC in FIGS. 7-12. Thus, reference identifiers used to designate the various components of the passenger cabin PC′ in FIGS. 13-14 are identical to those used for identifying the corresponding components of the passenger cabin PC in FIGS. 7-12, except that a “′” has been added to the identifier. Therefore, the structure and description for the various features of the automobiles in FIGS. 1-4 and passenger cabin PC in FIGS. 7-12 and how they're operated and controlled are understood to also apply to the corresponding features of the passenger cabin PC′ in FIGS. 13-14, except as described below.

FIGS. 13-14 shows the dashboard DB′ having a screen S′ that can be actuated to (move to) extend and retract relative to the dashboard DB′ between a first position (e.g., drive position) shown in FIG. 13 (having a relatively smaller height) and a second position (e.g., conference position) shown in FIG. 14 (having a relatively larger height). As discussed above, the larger dashboard DB′ made possible by the forward arrangement of the passenger cabin PC′ advantageously accommodates the screen S′ that can retract and extend relative to the dashboard DB′ to provide the screen S′ with a smaller height during driving (e.g., first position or driving position) or a larger height when the automobile or vehicle 100, 200 is parked (e.g., second position conference position). In one implementation, the screen S′ can have a height twice as great in the second position (e.g., extended position) than in the first position (e.g., retracted position). In another implementation, the screen S′ can have a height three times as great in the second position (e.g., extended position) as in the first position (e.g., retracted position. In another implementation, in the second position (e.g., extended position) the screen S′ extends to a location proximate the surface of the windshield WS′.

The screen S′ can have a greater width than height (whether in the first or the second position), and can extend from one end proximate one pillar AP′ and another end proximate another pillar AP′ (e.g., the screen S′ can extend along approximately an entire width of the dashboard DB′ between the pillars AP′). In one implementation, the screen S′ can be curved (e.g., in the width direction of the cabin PC′). In another implementation, the screen S′ can be flat (e.g., in the width direction of the cabin PC′). Further, the screen S′ can extend between the rear-view monitors M located proximate (e.g., adjacent) both sides of the screen S′ on the dashboard DB′.

In the driving position or first position (see FIG. 13), the screen S′ can show driving parameters (e.g., speedometer, odometer, battery charge level, etc.), cabin or outside parameters (e.g., outside ambient temperature, inside cabin temperature), navigation directions, and other parameters typically displayed in automobile dashboards. In the conference position or second position, the screen S′ can be used for entertainment (e.g., watching movies, videos), video conference calls or be connected (wirelessly) to a computer (e.g., laptop computer, tablet computer) while the automobile is parked. Accordingly, in the second or conference position, the screen S′ can be used as a workstation, or for an entertainment or cyber experience that is otherwise not possible for such a sized screen (width and/or height) because the distance to the eyes of the front row passengers would be too short in conventional dashboards. Due to the larger dashboard DB′ made possible by the forward passenger cabin arrangement of the automobile or vehicle 100, 200, the screen S′ is located at a distance from the front row passengers (e.g., distance from the eyes of the front row passengers) sufficient to allow the front row passengers to productively utilize the screen S′. For example, the screen S′ is located at a sufficient distance from the front row passengers so that the screen S′ cannot be reached with the outstretched arms of the front row passengers while seated in the front row seats.

As best shown in FIG. 16, the dashboard DB′ is stepped, with an upper dashboard portion DB1′ and a lower dashboard portion DB2′. The screen S′ can extend in front of the upper dashboard portion DB1′ and optionally can be supported by the upper dashboard portion DB1′.

With continued reference to FIGS. 13-14, the dashboard DB′ also has a touchscreen TS (in the lower dashboard portion DB2′) that the driver or passenger can interact with to, among other things, operate the screen S′ while it is in the first position or the second position. For example, the touchscreen TS can be used to operate the screen S', such as to initiate or end a video call, utilize the screen S′ as a workstation, such as to connect with a laptop computer or tablet computer, or use the screen S′ for entertainment, such as to play a movie.

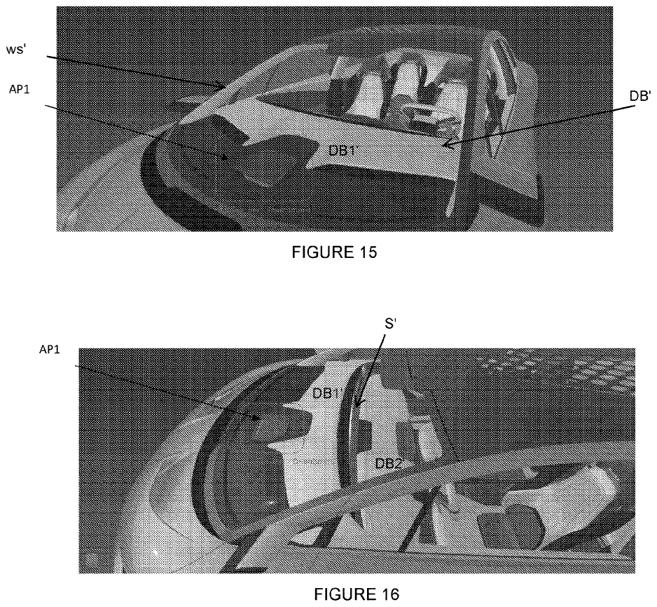

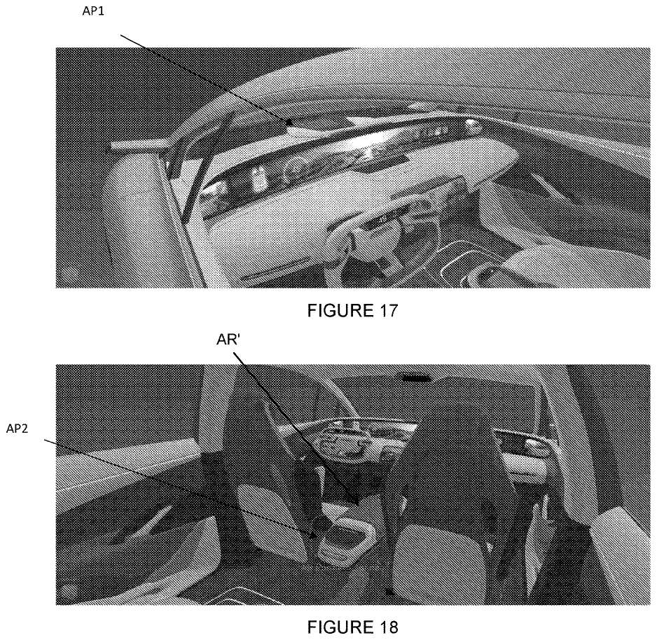

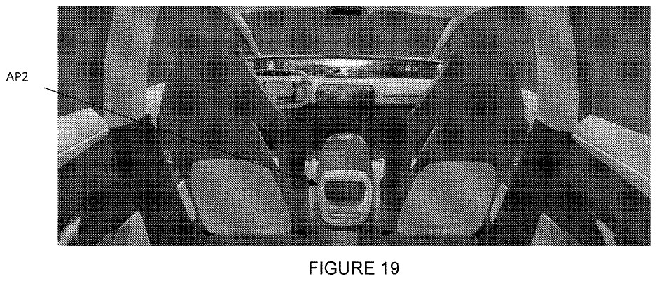

FIGS. 15-17 shows an air purifier AP1 on the dashboard DB′ (specifically on the upper dashboard portion DB1′). In one implementation, the air purifier AP1 is located centrally on the dashboard DB′ in the widthwise direction of the dashboard DB′. In one implementation, the air purifier AP1 is located proximate (e.g., adjacent) the windshield WS′. FIGS. 18-19 show a second air purifier AP2 in an arm rest AR′ for the front row passengers. The air purifier AP1 is operable to direct purified air toward the front row of passengers and the second air purifier AP2 is operable to directed purified air toward the rear row of passengers. The air purifier AP1 and the second air purifier AP2 can operate simultaneously or separately. Additionally, the air purifier AP1 and the second air purifier AP2 can be controlled at the same time (e.g., with a single input from a user, such as via the touch screen TS′), or can be operated separately (e.g. individually via separate inputs from a user, such as via the touch screen TS′).

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

1. An automobile, comprising:
a passenger cabin with two passenger rows between a wheelbase of the automobile; and
a windshield having a windshield touchdown location between a center of a front wheel of the automobile and a front end of the automobile,
wherein a second distance between the center of the front wheel and a foot position of a front passenger at a front of the passenger cabin is about 10-15% of the wheelbase, a third distance between the center of the front wheel and the front end of the automobile is about 25-35% of the wheelbase, a fourth distance between the windshield touchdown and the front of the automobile is about 15-25% of the wheelbase, a fifth distance between the windshield touchdown and the center of the front wheel is about 5-15% of the wheelbase, a sixth distance between an a-pillar of the automobile and the center of the front wheel is about 1-5% of the wheelbase and a seventh distance between the A-pillar and the front of the automobile is about 30-35% of the wheelbase.

2. The automobile of claim 1, wherein the windshield touchdown is located at or in front of a front edge of the front wheel of the automobile.

3. The automobile of claim 1, further comprising a dashboard having a depth between the windshield touchdown location and a distal end of the dashboard of between about 1080 mm and about 1220 mm.

4. The automobile of claim 3, further comprising a screen movable between a retracted driving position and an extended conference position relative to the dashboard, wherein in the retracted driving position the screen is configured to display driving parameters and wherein in the extended conference position the screen is configured to be used as a workstation or for entertainment or cyber experience.

5. The automobile of claim 4, wherein the screen extends between one end proximate one pillar of the passenger cabin and another proximate an opposite pillar of the passenger cabin.

6. The automobile of claim 4, wherein a steering wheel of the automobile is configured to move or fold downward when the screen is in the extended position.

7. The automobile of claim 4, further comprising video displays in a left end and a right end of the dashboard, said video displays in communication with rear-facing cameras on a left and right side of the automobile and configured to display images provided by the rear-facing cameras.

8. The automobile of claim 7, wherein the video displays are disposed adjacent opposite sides of the screen.

9. The automobile of claim 1, wherein a front row of the two passenger rows comprise a driver seat and a front passenger seat, the driver seat and the front passenger seat each having a seat back that folds onto a seat bottom, allowing passengers in a rear row of the two passenger rows to use the folded seats as leg rests.

10. The automobile of claim 3, further comprising an air purifier on the dashboard operable to direct purified air toward front row passengers in the passenger cabin.

11. The automobile of claim 1, further comprising a second air purifier in an arm rest for front row passengers that is operable to direct purified air toward rear row passengers in the passenger cabin.

12. The automobile of claim 1, wherein the windshield extends from the windshield touchdown at an angle between 60°and 70°.

13. The automobile of claim 1, wherein the wheelbase is within a range between about 3070 mm to about 3085 mm

14. An automobile, comprising:
a passenger cabin with two passenger rows between a wheelbase of the automobile;
a windshield having a windshield touchdown location between a center of a front wheel of the automobile and a front end of the automobile; and
a dashboard positioned adjacent to the windshield touchdown,
wherein a second distance between the center of the front wheel and a foot position of a front passenger at a front of the passenger cabin is about 10-15% of the wheelbase, a third distance between the center of the front wheel and the front end of the automobile is about 25-35% of the wheelbase.

15. The automobile of claim 14, wherein the wheelbase is within a range between about 3070 mm to about 3085 mm

16. The automobile of claim 14, further comprising video displays in a left end and a right end of the dashboard, said video displays in communication with rear-facing cameras on a left and right side of the automobile and configured to display images provided by the rear-facing cameras

17. The automobile of claim 14, wherein the dashboard has a depth between the windshield touchdown location and a distal end of the dashboard of between about 1080 mm and about 1220 mm.

18. The automobile of claim 14, further comprising a screen movable between a retracted driving position and an extended conference position relative to the dashboard, wherein in the retracted driving position the screen is configured to display driving parameters and wherein in the extended conference position the screen is configured to be used as a workstation or for entertainment or cyber experience, wherein the screen extends between one end proximate one pillar of the passenger cabin and another proximate an opposite pillar of the passenger cabin.

19. An automobile, comprising:
a passenger cabin with two passenger rows between a wheelbase of the automobile, wherein the wheelbase is within a range between about 3070 mm to about 3085 mm;
a windshield having a windshield touchdown location between a center of a front wheel of the automobile and a front end of the automobile;
a dashboard positioned adjacent to the windshield touchdown; and
a screen movable between a retracted driving position and an extended conference position relative to the dashboard, wherein in the retracted driving position the screen is configured to display driving parameters and wherein in the extended conference position the screen is configured to be used as a workstation or for entertainment or cyber experience, wherein the screen extends between one end proximate one pillar of the passenger cabin and another proximate an opposite pillar of the passenger cabin,
wherein a second distance between the center of the front wheel and a foot position of a front passenger at a front of the passenger cabin is about 10-15% of the wheelbase.

20. The automobile of claim 19, wherein the screen has a height at least twice as great in the conference position than in the retracted driving position.
